(19) United States
(12) Patent Application Publication
(10) Pub. No.: US 2008/0299532 A1
(43) Pub. Date: Dec. 4, 2008

(54) METHOD, SYSTEM, SIGNAL AND PROGRAM PRODUCT FOR ASSURING FEEDBACK IS RECEIVED FROM STUDENTS OF AN ONLINE COURSE

(75) Inventor: William W. Edgar, Brooksville, FL (US)

Correspondence Address: LARSON AND LARSON, 11199 69TH STREET NORTH, LARGO, FL, 33773, US

(73) Assignee: CEU PLAN, INCORPORATED, Spring Hill, FL (US)

(21) Appl. No.: 11/757,561

(22) Filed: Jun. 4, 2007

(51) Int. Cl. G09B 3/00

(52) U.S. Cl. 434/350

(57) ABSTRACT

An application for a system that assures feedback is provided from a student to a professor of an on-line course. The system includes a computer with at least a processor, memory and storage and software running on the computer for accepting inputs indicating the student feedback. Once the student feedback is entered by the student, the software running on the computer determines if the student feedback is valid, and if it is valid, the student feedback is provided to the professor and a final grade is provided to the student. If it is not valid, no final grade is provided.

### FIELD OF THE INVENTION

This invention relates to the field of teaching and more particularly to a system and method for assuring feedback is received from students attending an online course.

### BACKGROUND OF THE INVENTION

Many forms of teaching are currently being used to teach and train individuals. The traditional form is in a classroom using a many-on-one approach. Some educational institutes have created distributed or distance learning models in which the teacher/professor presents the class work in front of a video camera and the resulting video is distributed to other campuses or to the student's home/dormitory television. With the ubiquitous spread of computers and the internet, newer forms of teaching have become prevalent in which the training is provided by computer-based training (CBT) using slides, video segments and/or audio segments which are delivered to the student's computer on disk or through the Internet.

In all of these models, it is important for the teachers, professors, instructors and the like to receive qualitative feedback. Such feedback is essential for the teacher to understand deficiencies in the course plan, course material and presentation of such. Such feedback is useful to a teacher to make improvements to the course work and to their presentation skills. In addition, this feedback is useful to administrators in providing performance reviews.

For many teaching plans, the course material is presented in segments with short tests at the end of each segment to help the teacher measure the students' progress and judge when additional class or individual emphasis is needed. Often, a final examination is given to determine how much the students learned and retained during the training. After this, many teachers and institutions provide a course evaluation form for the students to complete and return, hopefully providing insights that will improve the curriculum and teaching experience for future classes. Often, the evaluation is not filled in or not returned. In such, the teacher and institution loose out on obtaining this valuable feedback.

The prior art has several examples of methods for teaching, but lack a method of enforcing the feedback forms be completed with useful information. For example, US Patent Publication 20060240396 to Foo describes a training system and method. This method includes a vast array of training providers and delivery tools and has provisions for the student to provide feedback as in FIG. 6F, but it does not provide any mechanism to assure feedback is received from virtually 100% of the students.

US Patent Publication 20050202390 to Allen, et al, describes a system and method for managing course evaluation surveys. This application describes an automated method of distributing and collecting course evaluations as well as delaying delivery of such evaluations to the professor until after grades are set and delivered, but has no provision to assure feedback is received from virtually 100% of the students.

US Patent Publication 20050186550 to Gillani describes a system and method for learning based upon continuing student assessment and responses. This application includes a mechanism for students to complete course evaluations, but has no provision to assure feedback is received.

US Patent Publication 20040152064 to Raniere describes an electronic course evaluation. This application describes an automated method of managing course evaluations, but has no provision to assure feedback is received from virtually 100% of the students.

U.S. Pat. No. 6,789,047 to Woodson describes a method for evaluating an instructor using data captured during an electronic course (online) such as attendance and response time to questions but has no provision to assure feedback is received.

U.S. Pat. No. 6,654,588 to Moskowitz, et al, describes a system to provide presentation evaluations in real-time using audience devices but has no provision to assure feedback is received.

U.S. Pat. No. 6,652,287 to Strub, et al, describes an administrator and instructor course management application for an online course. It describes models for displaying the feedback from students but has no provision to assure feedback is received.

U.S. Pat. No. 6,347,333 to Eisendrath, et al, describes a virtual online campus. This patent discusses student reviews of the course but has no provision to assure feedback is received.

What is needed is a system and method that will not only present an opportunity for a student to provide valuable feedback to their teacher, but will require such feedback before a final grade is delivered.

### SUMMARY OF THE INVENTION

In one embodiment, a system for assuring feedback is provided from a student to a professor of an on-line course, includes a computer with at least a processor, memory and storage and software running on the computer for accepting inputs indicating the feedback. Once the feedback is entered by the student, the software running on the computer determines if the feedback is valid, and if it is valid, the feedback is provided to the professor and a final grade is provided to the student.

In another embodiment, a method for assuring feedback is provided from a student to a professor of an on-line course includes accepting inputs containing the feedback and determining if the feedback is valid. If the feedback is valid, providing a final grade to the student.

In another embodiment, a computer readable medium tangibly embodying a program of instructions, the program of instructions configured to assure feedback is provided from a student to a professor of an on-line course, the program of instructions includes instructions for accepting inputs containing the feedback and instructions for determining if the feedback is valid. If the feedback is valid, additional instructions execute for providing a final grade to the student.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a first flow chart of all embodiments of the present invention.

FIG. 2 illustrates a flow chart of the student feedback process of all embodiments of the present invention.

FIG. 3 illustrates a flow chart of the student feedback process of all embodiments of the present invention.

FIG. 4 illustrates a schematic view of a typical computer system of all embodiments of the present invention.

FIG. 5 illustrates a sample electronic feedback form of all embodiments of the present invention.

FIG. 6 illustrates a properly completed sample electronic feedback form of all embodiments of the present invention.

FIG. 7 illustrates an improperly completed sample electronic feedback form of all embodiments of the present invention.

FIG. 8 illustrates a flow chart of an exemplary method of determining if the provided feedback is valid of all embodiments of the present invention.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures. Online training is any type of distance education including, but not limited to, self-study and professor-led training.

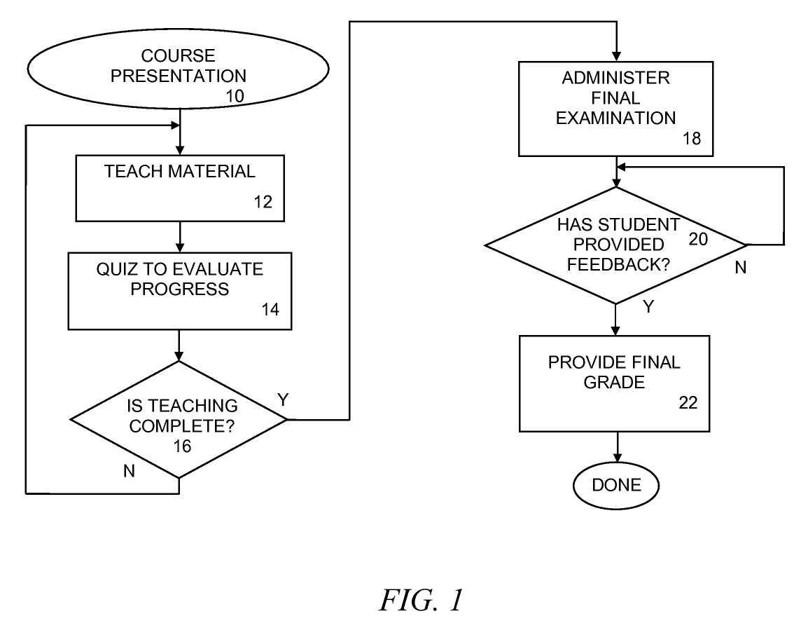

Referring to FIG. 1, a flow chart of all embodiments of the present invention will be described. The accepted norm for teaching or presenting a course 10 is to pre-test 12 the students 12 to evaluate their base knowledge of the subject. The professor then teaches a subset of the material 14, evaluates what the student has learned with quizzes or other tools 15 and then when the entire course is complete 16, administers a final examination 18 to determine if the students have successfully mastered what was taught. In many situations, the subset of material 14 is a chapter in a text book or an individual concept such as Ohm's law or Kirchoff's Law.

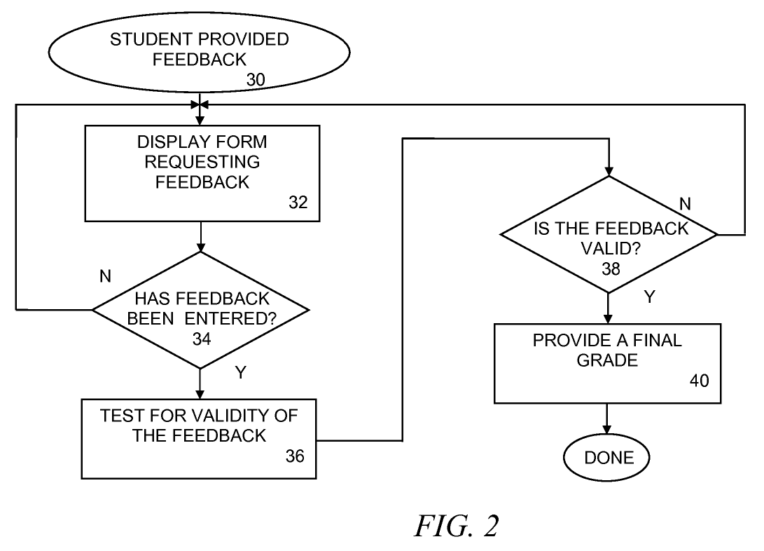

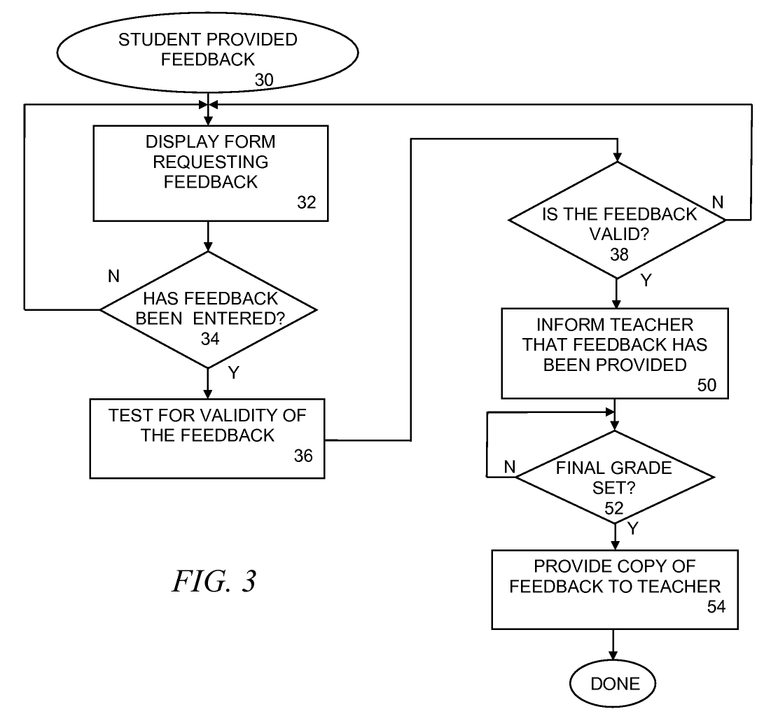

After completion of the course, it would be ideal to obtain substantive feedback from each student. In the past, feedback forms were provided (electronically or on paper) but there was little or no method employed to assure the form was filled out and returned, let alone filled out with substantive information. The present invention addresses this by requesting feedback electronically 20 and, waiting until the student provides meaningful feedback 20 before providing a final grade 22. The step of requesting student feedback is further described in FIGS. 2 and 3. In some embodiments, the student feedback is captured and stored in the student's permanent record or profile.

Referring to FIG. 2, a flow chart of the student feedback process of all embodiments of the present invention is described. The process of requesting and obtaining student feedback 30 includes displaying a form requesting feedback 32. In some embodiments, the form includes places for the student to provide free-form text responses. In some embodiments, the feedback form includes multiple choice responses. In still other embodiments, the feedback form includes both free-form text responses and multiple choice responses.

After the form is displayed, the user has the opportunity to select the multiple choice selections and enter free-form text. Once feedback has been entered 34, it is checked for validity 36 to make sure the student didn't enter useless text and selections. Once it is determined that valid feedback has been delivered 38, a final grade is provided to the student 40. Therefore, the student is incentivized to complete the feedback form and provide the feedback to the teacher if they want to receive a grade for the course.

Referring to FIG. 3, a flow chart of the student feedback process of a second embodiment of the present invention is described. The process of requesting and obtaining student feedback 30 includes displaying a form requesting feedback 32. In some embodiments, the form includes places for the student to provide free-form text responses. In some embodiments, the feedback form includes multiple choice responses. In still other embodiments, the feedback form includes both free-form text responses and multiple choice responses.

After the form is displayed, the user has the opportunity to select the multiple choice selections and enter free-form text. Once feedback has been entered 34, it is checked for validity 36 to make sure the student didn't enter useless text and selections. Once it is determined that valid feedback has been delivered 38, The instructor is informed that sufficient feedback has been provided by the student so the instructor can issue a final grade 50. After the instructor issues the final grade 52, the instructor is provided with a copy of the feedback 54. This process prevents the instructor from seeing the feedback until the final grade is issued, thereby preventing any bias.

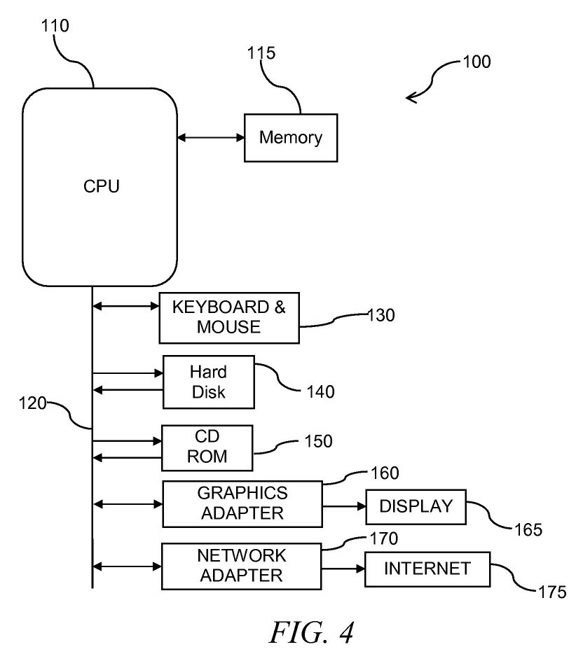

Referring to FIG. 4, a typical computer 100 configuration of the present invention is shown. This exemplary configuration is well known in the prior art. Although shown in a much simplified configuration having a single processor, many different computer architectures are known that accomplish similar results in a similar fashion and the present invention is not limited in any way to any particular computer system. The present invention works well utilizing a single processor system as shown; a multiple processor system where multiple processors share resources such as memory and storage; or a multiple server system where several independent servers operate in parallel or any combination. In this, a processor 110 is provided to execute stored programs that are generally stored for execution within a memory 115. The processor 110 can be any processor or a group of processors, for example an Intel Pentium-4® CPU or the like. The memory 115 is connected to the processor and can be any memory suitable for connection with the selected processor 110, such as SRAM, DRAM, SDRAM, RDRAM, DDR, DDR-2, etc. Also connected to the processor 110 is a system bus 120 for connecting peripheral subsystems such as a keyboard/mouse 130, a hard disk 140, a CDROM 150, graphics adapter 160 and network adapter 170. The graphics adapter 160 receives commands and display information from the system bus 120 and generates a display image that is displayed on the display 165. The network adapter 170 receives commands and data from the system bus 120 and communicates with the World Wide Web or Internet 175, through a modem or other communication device (not shown).

In general, the hard disk 140 may be used to store programs, executable code and data persistently, while the CDROM 150 may be used to load said programs, executable code and data from removable media onto the hard disk 140. These peripherals are meant to be examples of input/output devices, persistent storage and removable media storage. Other examples of persistent storage include core memory, FRAM, flash memory, etc. Other examples of removable media storage include CDRW, DVD, DVD writeable, compact flash, other removable flash media, floppy disk, ZIP®, laser disk, etc. In some embodiments, other devices are connected to the system through the system bus 120 or with other input-output connections. Examples of these devices include printers; mice; graphics tablets; joysticks; and communications adapters such as modems and Ethernet adapters.

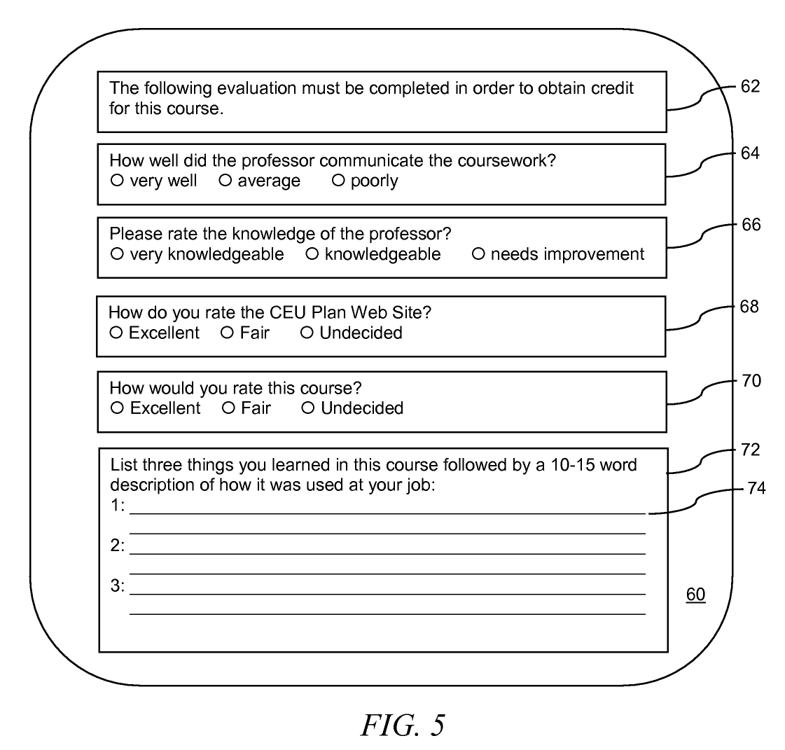

Referring to FIG. 5, a typical electronic feedback form 60 of the present invention is shown. This exemplary form 60 is presented to the student (step 32 from FIG. 2 and FIG. 3) after completion of the course and is required to be completed before the student receives a grade or successful completion. This fact is conveyed to the student in the first text area 62. In this exemplary form, several multiple-choice selections 64/66/68/70 are provided the student to rate how well the professor communicated 64, the knowledge of the professor 66, the web site 68 and the course itself 70. Also included is a free-form text field 72 that requests the student enter description information 74.

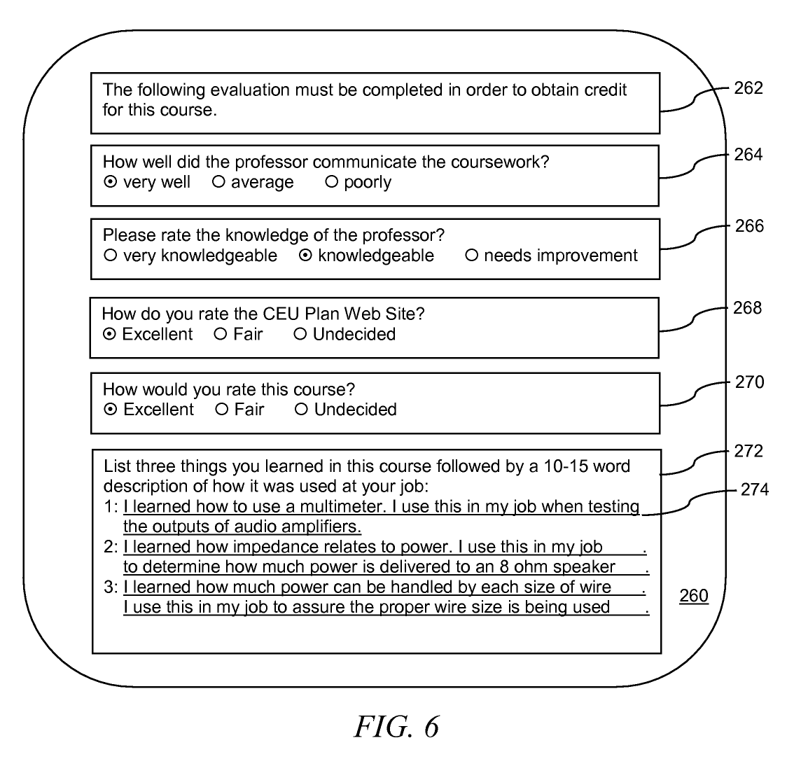

Referring to FIG. 6, a properly completed typical electronic feedback form 260 of the present invention is shown. This completed exemplary form 260 is presented to the student (step 32 from FIG. 2 and FIG. 3) after completion of the course and is required to be completed before the student receives a grade or successful completion. This fact is conveyed to the student in the first text area 262. The form has several multiple-choice selections 264/266/268/270 where the student must rate how well the professor communicated 264 (very well), the knowledge of the professor 266 (knowledgeable), the web site 268 (excellent) and the course itself 270 (excellent). In this example, the free-form text field 72 has been completed by the student with properly described information 274.

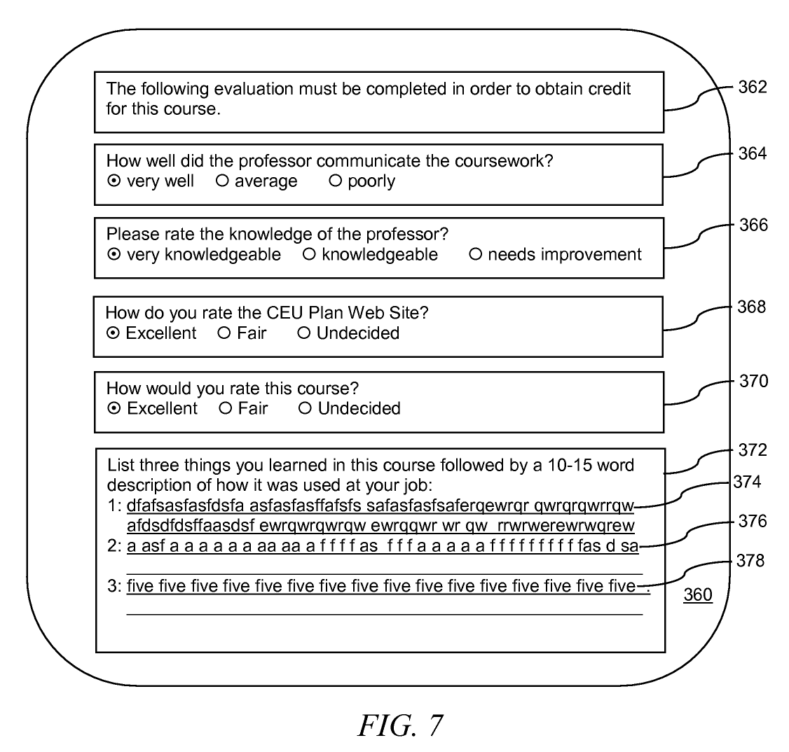

Referring to FIG. 7, an improperly completed typical electronic feedback form 360 of the present invention is shown. This exemplary form 360 is presented to the student (step 32 from FIG. 2 and FIG. 3) after completion of the course and is required to be completed before the student receives a grade or successful completion. This fact is conveyed to the student in the first text area 362. The form has several multiple-choice selections 364/366/368/370 where the student rated how well the professor communicated 364, the knowledge of the professor 366, the web site 368 and the course itself 370. As can be seen, the student chose the first selection in each category (very well, very knowledgeable and excellent). In this example, the free-form text field 372 was filled with useless information 374/376/378. Apparently, the student didn't bother to provide any useful feedback and attempted to satisfy the requirement to provide feedback by typing random responses and text.

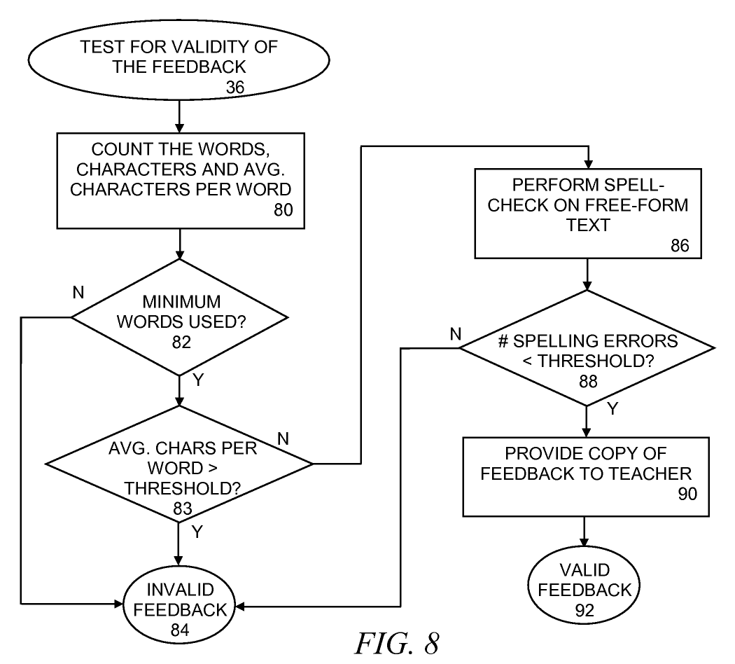

Referring to FIG. 8, one method of determining if the feedback provided is valid is shown. In FIG. 2 and FIG. 3, a step asked if the feedback is valid 36. The flow chart of FIG. 8. presents an example of how this test for validity is performed. There are many ways to provide a confident determination of the validity and type of text of a particular language. In the example shown relating to English text, the first step 80 is to count the number of words, the number of characters (letters) and the average number of characters per word. In some embodiments, the number of characters per word is determined by dividing the total number of characters by the total number of words. After these counts are measured, a test is made to determine if the minimum number of words is sufficient 82. If there are too few words, it is determined that the feedback is invalid 84. For example, if only 5 words were entered, such would not constitute enough feedback as to assume that the feedback is valid. Similar steps are performed for feedback responses in languages other than English.

Next, the average number of characters per word is compared to a threshold 83. If the average is greater than this threshold, then it is determined that the feedback is invalid 84. Most English text includes an average of 4-6 letters per word. When a person types just to fill in lines, often the average number of letters per word is above eight.

Next, a spelling check is performed on the text 86. Often, when one provides useless feedback, they type garbage words or, at the least, don't bother to spell correctly. In this example, the number of spelling errors detected is compared to spelling error threshold 88 and, if the number of errors is less than the threshold 88, it is determined that the feedback is valid 92 and a copy of the feedback is provided to the teacher 90. If the number of errors is greater than or equal to the threshold 88, it is determined that the feedback is invalid 84

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for assuring feedback is provided from a student to a professor of an on-line course, the system comprising:
a computer including at least a processor, memory and storage;
software running on the computer for accepting inputs indicating the feedback from the student;
software running on the computer for determining if the feedback is valid;
software running on the computer for providing the feedback to the professor only if the feedback is valid; and
software running on the computer for providing a final grade from the professor to the student.

2. The system for assuring feedback is provided from a student to a professor of an on-line course of claim 1, wherein the software running on the computer for determining if the feedback is valid includes software that counts a number of words in the feedback and if the number of words is greater than a word-count-threshold, the software that counts the number of words in the feedback indicates that the feedback is valid.

3. The system for assuring feedback is provided from a student to a professor of an on-line course of claim 1, wherein the software running on the computer for determining if the feedback is valid include software that determines an average length of words in the feedback and if the average length of words is within an acceptable range, the software that determines the average length of words in the feedback indicates the feedback is valid.

4. The system for assuring feedback is provided from a student to a professor of an on-line course of claim 1, wherein the software running on the computer for determining if the feedback is valid includes software that performs a spelling check on the feedback and if the spelling check detects an acceptable number of spelling errors, the software that performs the spelling check on the feedback indicates the feedback is valid.

5. The system for assuring feedback is provided from a student to a professor of an on-line course of claim 1, wherein the software running on the computer for providing the feedback to the professor does not provide access to the feedback to the professor until a final grade is presented to the student at which time access is provided to the feedback for the professor.

6. A method for assuring feedback is provided from a student to a professor of an on-line course, the method comprising:
accepting inputs containing the feedback from the student;
determining if the feedback is valid; and
if the feedback is valid, providing a final grade to the student.

7. The method of claim 6, wherein the step of determining if the feedback is valid includes counting a number of words in the feedback and if the number of words is greater than a word-count-threshold, indicating the feedback is valid.

8. The method of claim 6, wherein the step of determining if the feedback is valid includes determining an average length of words in the feedback and if the average length of words is within an acceptable range, indicating the feedback is valid.

9. The method of claim 6, wherein the step of determining if the feedback is valid includes performing a spelling check on the feedback and if the spelling check detects an acceptable number of spelling errors, indicating the feedback is valid.

10. The method of claim 6, wherein the step of providing the feedback to the professor further includes a step of determining if the professor has provided a final grade and after the professor has provided the final grade, providing access to the feedback for the professor.

11. A computer readable medium tangibly embodying a program of instructions, the program of instructions configured to assure feedback is provided from a student to a professor of an on-line course, the program of instructions comprising:
computer instructions for accepting inputs containing the feedback from the student;
computer instructions for determining if the feedback is valid; and
if the feedback is valid, computer instructions providing a final grade from the professor to the student.

12. The computer readable medium tangibly embodying a program of instructions, the program of instructions configured to assure feedback is provided from a student to a professor of an on-line course of claim 11, wherein the step of determining if the feedback is valid includes performing a spelling check on the feedback and if the spelling check detects an acceptable number of spelling errors, indicating the feedback is valid

13. The computer readable medium tangibly embodying a program of instructions, the program of instructions configured to assure feedback is provided from a student to a professor of an on-line course of claim 11, wherein the step of determining if the feedback is valid includes counting a number of words in the feedback and if the number of words is greater than a word-count-threshold, indicating the feedback is valid.

14. The computer readable medium tangibly embodying a program of instructions, the program of instructions configured to assure feedback is provided from a student to a professor of an on-line course of claim 11, wherein the step of determining if the feedback is valid is includes determining an average length of words in the feedback and if the average length of words is within an acceptable range, indicating the feedback is valid.

15. The computer readable medium tangibly embodying a program of instructions, the program of instructions configured to assure feedback is provided from a student to a professor of an on-line course of claim 11, wherein the step of providing the feedback to the professor further includes a step of determining if the professor has provided a final grade once the professor has provided the final grade, providing access to the feedback for the professor.
